(19) United States
(12) Patent Application Publication
(10) Pub. No.: US 2006/0169938 A1
(43) Pub. Date: Aug. 3, 2006

(54) Audio-emitting sanitary fixture flusher indicator

(76) Inventor: Alex Woo, Taichung City (TW)

Correspondence Address: RABIN & BERDO, P.C.;Suite 500, 1101 14th Street, N.W., Washington, DC, 20005, US

(21) Appl. No.: 11/043,922

(22) Filed: Jan. 28, 2005

(51) Int. Cl. F16K 31/02

(52) U.S. Cl. 251/129.04

(57) ABSTRACT

An audio-emitting sanitary fixture flusher indicator consists of a water control valve, an IC processing unit capable of controlling water output state, an infrared sensor component, a display screen, and an amplifier component, the individual circuits of which are interconnected. When the user enters the effective, a message shown on the display screen and a tone along with the transmission of music fosters a relaxed mood during use. After the user is finished and leaves the indicator and the original effective, an appropriate volume of water for rinsing and flushing is released, a message is shown on the display screen, and an audible prompt informs the next user that the indicator has already completed its cleaning task and assures readiness for further use. As such, the integrated audio and on-screen notification capability of the present invention effectively facilitates convenient utilization as well as a tranquil mood.

### BACKGROUND OF THE INVENTION

1) Field of the Invention

The invention herein relates to an audio-emitting sanitary fixture flusher indicator, specifically an indicator installed on a sanitary fixture, wherein the said indicator consists of a water control valve, an IC processing unit, an infrared sensor component, a display screen, and an amplifier component that are all interconnected. As such, the integrated audio and on-screen notification capability of the present invention effectively facilitates convenient utilization as well as a tranquil mood.

2) Description of the Prior Art

New sanitary fixture flusher designs are introduced daily and some are certainly progressive. For example, a typical feature is automatic flusher actuation before and after toilet use, wherein it is only necessary to approach and be sensed by the flusher to trigger automatic flushing action. However, following long-term use it has been discovered that after the automatic flusher is approached and an automatically sensed flushing occurs, a second automatically sensed flush takes place during the wait silence before the departure of the user. As such, although only a brief period amounting to several tens of seconds transpires, if the user is uneasy and unable to calm down, a subsequent series of brief periods becomes one or two minutes or even an ordeal lasting from one to 20 minutes. Without an atmosphere of relaxation, completion of urination may take quite a while.

### SUMMARY OF THE INVENTION

Therefore, in view of the said situation, the applicant of the invention herein conducted extensive observation and research, culminating in the development of the present invention, which is submitted in application for patent rights.

The primary objective of the invention herein is to provide an audio-emitting sanitary fixture flusher indicator that is an indicator installed on a sanitary fixture, the said indicator consisting of a water control valve, an IC processing unit capable of controlling water output state, an infrared sensor component, a display screen, and an amplifier component, the individual circuits of which are interconnected. As such, when the user enters the effective, limited sensing range of the indicator infrared sensor component, a small-volume stream of water is issued for a preliminary rinse and, at the same time, a message shown on the display screen and a tone along with the transmission of music fosters a relaxed mood during use. After the user is finished and leaves the indicator and the original effective, limited sensing range of the infrared sensor component is restored, an appropriate volume of water for rinsing and flushing is released, a message is shown on the display screen, and an audible prompt informs the next user that the indicator has already completed its cleaning task and assures readiness for further use. As such, the integrated audio and on-screen notification capability of the present invention effectively facilitates convenient utilization as well as a tranquil mood.

### BRIEF DESCRIPTION OF THE DRAWINGS

FIG. 1-A is an exploded drawing of the installation structure of the invention herein.

FIG. 1-B is an isometric drawing of the water valve position of the invention herein.

FIG. 1-C is an orthographic drawing of the water valve position of the invention herein.

FIG. 1-D is a cross-sectional drawing the structure of the invention herein after installation.

FIG. 2-A is a cross-sectional drawing of the invention herein before utilization.

FIG. 2-B is orthographic drawing of the invention herein before utilization.

FIG. 3-A is a cross-sectional drawing of the invention herein when a person approaches.

FIG. 3-B is an orthographic drawing of the invention herein when a person approaches.

FIG. 4-A is a cross-sectional drawing of the invention herein during usage by a person.

FIG. 4-B is an orthographic drawing of the invention herein during usage by a person.

FIG. 5-A is a cross-sectional drawing of the invention herein following usage by a person.

FIG. 5-B is an orthographic drawing of the invention herein following usage by a person.

FIG. 6 is a cross-sectional drawing of the invention herein when equipped with a graphics LCD screen.

### DETAILED DESCRIPTION OF THE PREFERRED EMBODIMENTS

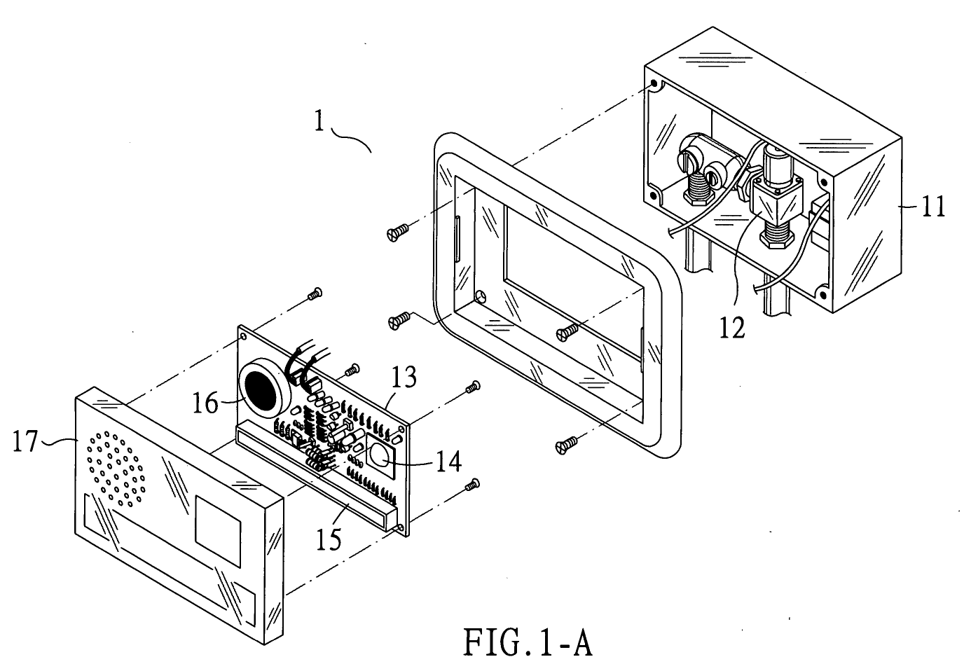

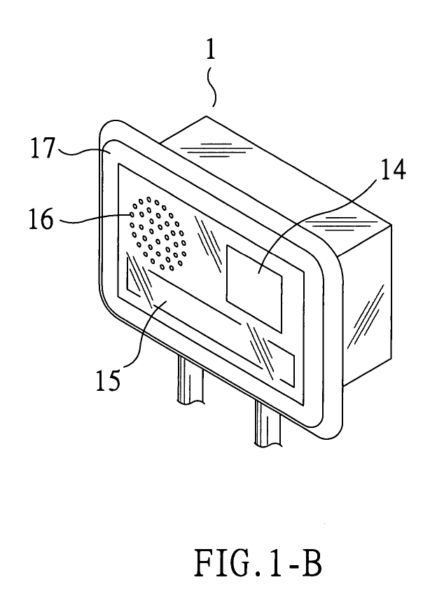

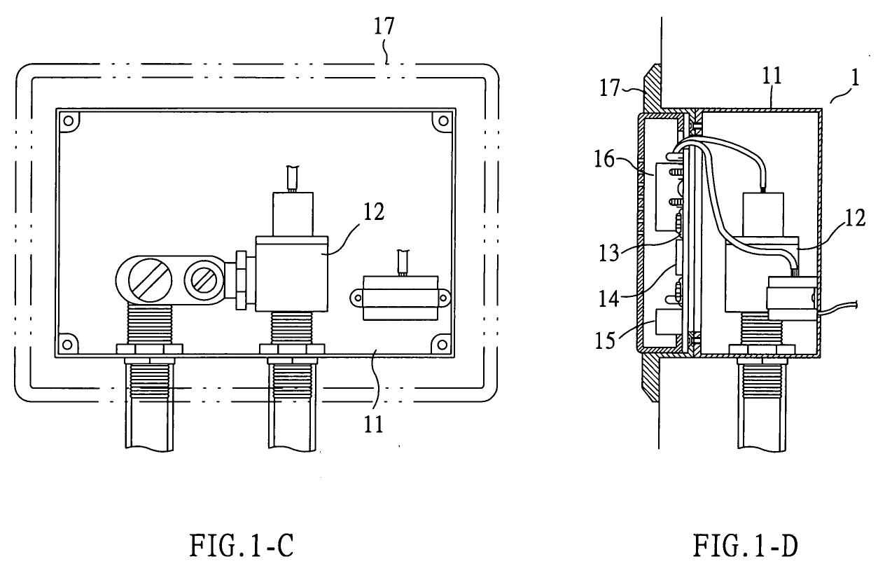

Referring to FIG. 1-A, FIG. 1-B, FIG. 1-C, and FIG. 1-D, the audio-emitting sanitary fixture flusher indicator of the invention herein is an indicator 1 installed on a sanitary fixture 2 (a urinal), the said indicator 1 consisting of an enclosure 11 housing a water control valve 12, an IC processing unit 13 capable of controlling water output state, an infrared sensor component 14, a display screen 15, and an amplifier component 16, the individual circuits of which are interconnected and wherein the IC processing unit 13 is pre-programmed for many function indications in various written and spoken international languages as well as for music or broadcast system connectivity, and following which a cover 17 is emplaced.

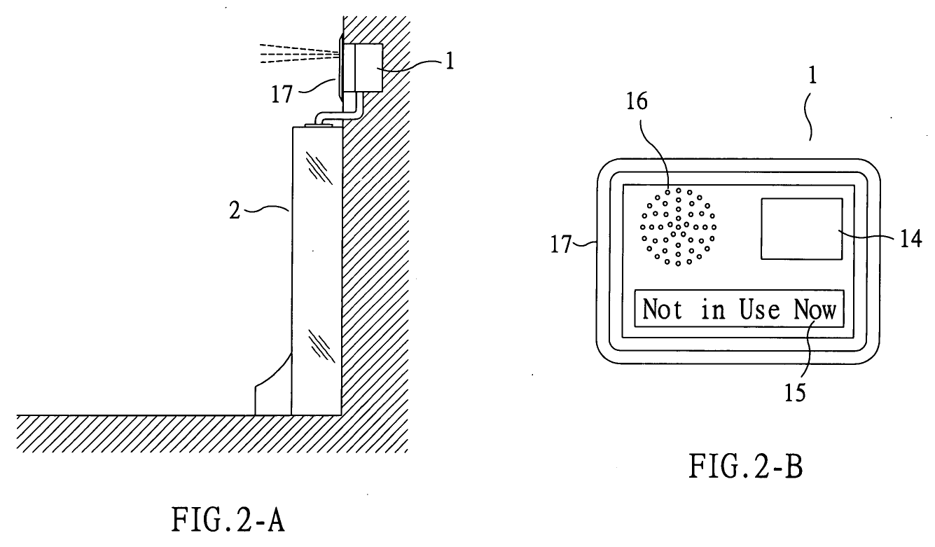

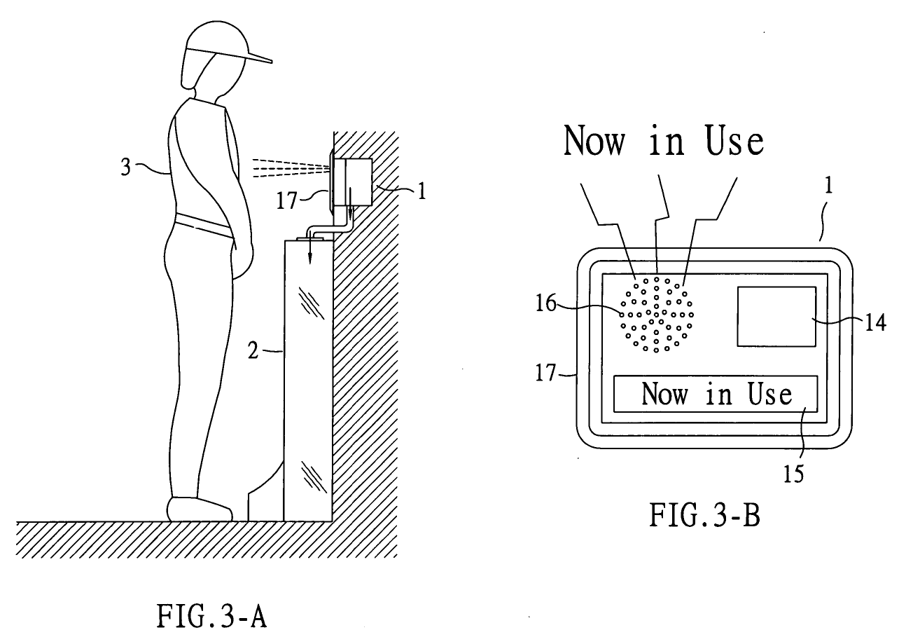

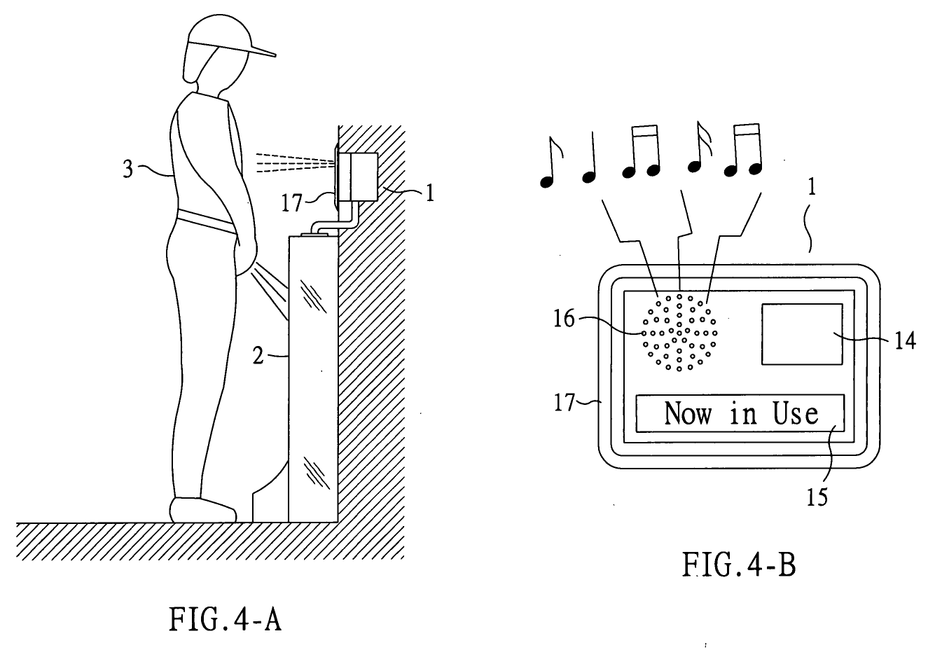

As such, after the indicator 1 is installed into position on the sanitary fixture 2 (a urinal), the infrared sensor component 14 that switches on power to the indicator 1 transmits an infrared beam having a set effective, limited sensing range and distance, while the words “Not in Use Now” are shown on the display screen 15 with the amplifier component 16 remaining in silent mode (as shown in FIG. 2-A and FIG. 2-B); when the user 3 enters the effective, limited sensing range of the indicator 1 infrared sensor component 14, the human body shortens the original sensing distance of the infrared beam, at which time the indicator 1 IC processing unit 13 causes the water control valve 12 to issue a small-volume stream of water for a preliminary rinse and, at the same time, the words “Now in Use” are shown on the display screen 15 and the amplifier component 16 emits a tone (as shown in FIG. 3-A and FIG. 3-B) followed by the transmission of soft soothing music(as shown in FIG. 4-A and FIG. 4-B) to foster a relaxed mood.

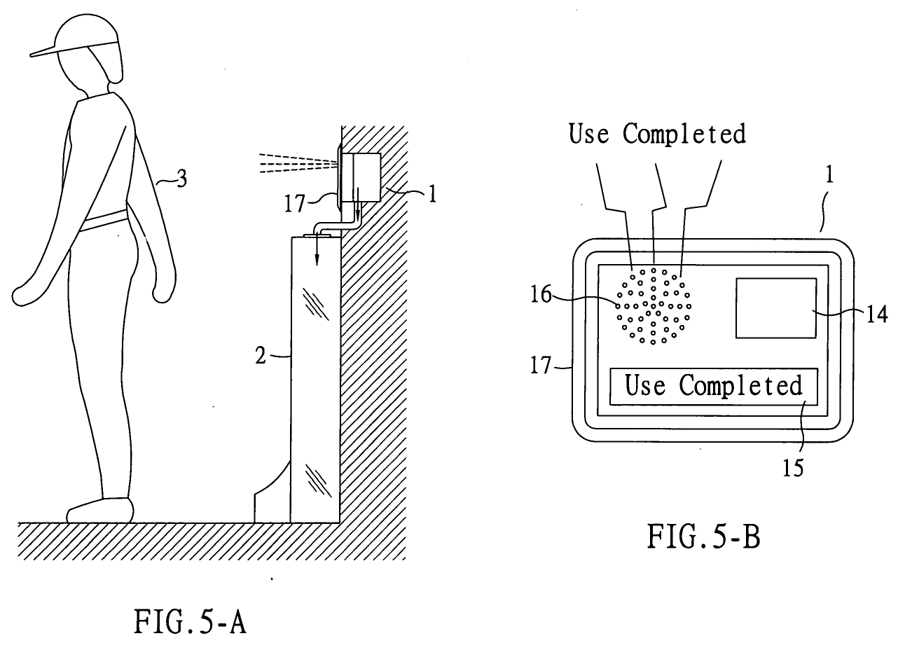

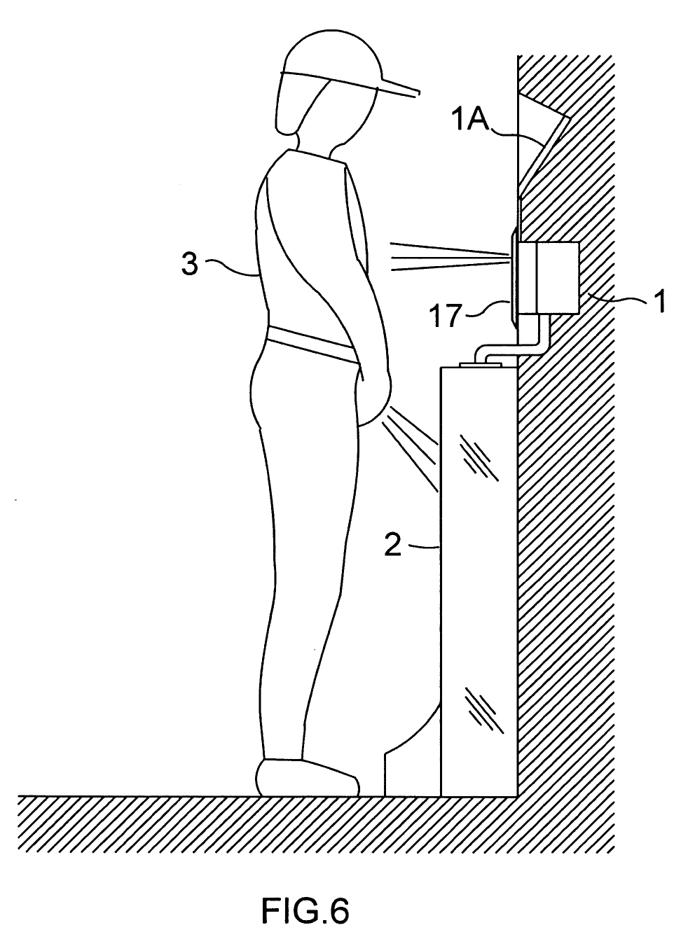

When the user is finished and leaves the indicator 1, thereby restoring the original effective, limited sensing range of the infrared sensor component 14, the water control valve 12 once again opens to release an appropriate volume of water for rinsing and flushing, the words “Use Completed” are shown on the display screen 15, and the amplifier component 16 audibly informs the next user that the indicator 1 has already completed its cleaning task and assures readiness for further use (as shown in FIG. 5-A and FIG. 5-B), following which there is a return to the state depicted in FIG. 2-A and FIG. 2-B; as such, the audio and on-screen notifications effectively facilitates convenient utilization. Furthermore, a graphics liquid crystal display screen 1A (as shown in FIG. 6) is additionally installed on the indicator to further provide for user mood relaxation.

In the event of indicator 1 abnormality, when due to internal circuit problems or insufficient electrical power, then the words “Malfunction. Please Do Not Use.” appear on the display screen 15 and the amplifier component 16 sounds a prompt to that effect, thereby alerting users and cleaning personnel to inspect and repair immediately.

In summation of the foregoing section, possessing demonstrable functional utility, the invention herein complies with the patent application requirements stipulated in Article 93 of the Patent Law and is lawfully submitted to the Patent Bureau for review and the granting of the commensurate patent rights.

1. An audio-emitting sanitary fixture flusher indicator that is an indicator installed on a sanitary fixture, the said indicator consisting of an enclosure housing a water control valve, an IC processing unit capable of controlling water output state, an infrared sensor component, a display screen, and an amplifier component, the individual circuits of which are interconnected and wherein the said IC processing unit is pre-programmed for many function indications in various written and spoken international languages as well as for music or broadcast system connectivity, and following which a cover is emplaced; as such, the integrated audio and screen notification capability of the present invention effectively facilitates convenient utilization as well as a tranquil mood.
